(19) United States
(12) Patent Application Publication
(10) Pub. No.: US 2015/0233148 A1
(43) Pub. Date: Aug. 20, 2015

(54) PADLOCK WITH INDICATION DEVICE

(71) Applicant: Chun Te YU, CHANGHUA COUNTY (TW)

(72) Inventor: Chun Te YU, CHANGHUA COUNTY (TW)

(21) Appl. No.: 14/705,510

(22) Filed: May 6, 2015

Related U.S. Application Data
(63) Continuation of application No. 13/541,855, filed on Jul. 5, 2012.
Application No. 13/541,855 is a continuation of application No. 12/814,183, filed on Jun. 11, 2010, now Pat. No. 8,256,250.
Application No. 12/814,183 is a continuation-in-part of application No. 11/491,258, filed on Jul. 24, 2006, now Pat. No. 7,770,421.
Application No. 11/491,258 is a continuation-in-part of application No. 11/032,116, filed on Jan. 11, 2005, now Pat. No. 7,100,401.

(30) Foreign Application Priority Data
Nov. 23, 2004 (TW) 93218813

(51) Int. Cl. E05B 67/06; E05B 39/00

(52) U.S. Cl. CPC E05B 67/06; E05B 39/00

(57) ABSTRACT

A padlock includes a shell, a shackle, a limit knob, an indicator and a lock core. The shell includes an opening in a wall thereof The shackle includes a long section movably inserted in the shell, and a short section extended from the long section and located out of the shell. The limit knob is partly received in the shell via the opening and includes a button located out of the shell. The indicator is disposed on the limit knob and capable of moving to a predetermined position which is out of the shell. The lock core includes a rotor configured to be driven by a key so as to move the limit knob to a first position where the button of the limit knob keeps the shackle from rotating and a second position where the button of the limit knob allows the shackle to rotate.

### CROSS REFERENCE TO RELATED APPLICATIONS

This is a continuation of co-pending application Ser. No. 13/541,855, filed Jul. 5, 2012, which is a continuation of application Ser. No. 12/814,183, filed Jun. 11, 2010, which issued as U.S. Pat. No. 8,256,250 on Sep. 4, 2012, which is a continuation-in-part of U.S. application Ser. No. 11/491,258, filed on Jul. 24, 2006, which issued as U.S. Pat. No. 7,770,421 on Aug. 10, 2010, which is a continuation-in-part of U.S. application Ser. No. 11/032,116 filed on Jan. 11, 2005, which issued as U.S. Pat. No. 7,100,401 on Sep. 5, 2006, for which priority is claimed under 35 U.S.C.§ 120; and this application claims priority of Application No. 093218813 filed in Taiwan, R.O.C. on Nov. 23, 2004 under 35 U.S.C.§119; the entire contents of all of which are hereby incorporated by reference.

### BACKGROUND OF THE INVENTION

1. Field of the Invention

The present invention relates to a padlock and, more particularly, to a padlock with an indication device for reminding a padlock owner whose padlock has been operated or used and luggage may have been inspected by the customs.

2. Brief Description of the Related Art

A conventional dual lock or padlock generally includes a shell, a shackle installed on the shell, a first locking mechanism installed on the shell to lock and unlock the shackle, and a second locking mechanism installed on the shell to lock and unlock the shackle. The first locking mechanism can only be unlocked by a padlock owner while the second locking mechanism can be unlocked only by a specific key. The specified key is often held by a customs inspector who is authorized to unlock the second locking mechanism of the padlock when it is necessary to open and check a luggage, a case or a bag subject to the lock or padlock without breaking it. Then, the inspector can re-lock the lock or padlock via the second locking mechanism by the specified key after inspecting the luggage, case or bag. However, an owner of such a luggage, case or bag cannot judge by the appearance of the lock or padlock if the lock or padlock has been operated or used and the luggage, case or bag has been checked that would cause great inconvenience to the owner.

### SUMMARY OF THE INVENTION

The primary objective of the present invention is to provide a padlock capable of reminding a padlock owner whose padlock has been operated or used and luggage may have been inspected by the customs.

In an embodiment of the present invention, a padlock comprises a shell, a shackle, a lock mechanism and an indicator. The shell includes an opening made in a wall thereof to communicate an interior space of the shell and the out of the shell. The shackle is mounted on the shell and formed with a long section movably inserted in the shell and a short section extending from the long section so that they are movable together. The lock mechanism is mounted on the shell, and includes a lock core and a limit knob. The lock core is inserted in the shell. The limit knob comprises a driving member and a button. The driving member is movable within the interior space of the shell via the opening. The button is coupled to the driving member and located out of the shell. The driving member is movable by the lock core so as to drive the button to engage with or disengage from the short section of the shackle. The indicator is disposed in the opening of the shell and capable of moving along a surface of the driving member from the opening of the shell to an indication position out of the shell by operating the lock core of the lock mechanism.

Further benefits and advantages of the present invention will become apparent after a careful study of the detailed description with reference to the accompanying drawings.

### BRIEF DESCRIPTION OF THE DRAWINGS

The present invention will be described via detailed illustration of the preferred embodiment referring to the drawings wherein:

FIG. 1 is a cutaway view of a padlock in accordance with a first embodiment of the present invention;

FIG. 2 is a perspective view of the padlock shown in FIG. 1;

FIG. 3 is another perspective view of the padlock shown in FIG. 1;

FIG. 4 is a perspective view of the padlock in another position than that is shown in FIG. 3;

FIG. 5 is an exploded partial view of the padlock shown in FIG. 1;

FIG. 6 is another exploded partial view of the padlock shown in FIG. 1;

FIG. 7 is an exploded partial view of the padlock in another position than that is shown in FIG. 5;

FIG. 8 is a perspective partial view of the padlock shown in FIG. 1;

FIG. 9 is a side view of the padlock shown in FIG. 1;

FIG. 10 is a side view of the padlock in another position than that is shown in FIG. 9;

FIG. 11 is a perspective view of a padlock in accordance with a second embodiment of the present invention;

FIG. 12 is an exploded partial view of the padlock shown in FIG. 11.

FIG. 13 is a top view of the padlock shown in FIG. 12;

FIG. 14 is a top view of the padlock in another position than that is shown in FIG. 13;

FIG. 15 is a top view of the padlock in another position than that is shown in FIG. 14;

FIG. 16 is a perspective view of a padlock in accordance with a third embodiment of the present invention;

FIG. 17 is a perspective view of a padlock in accordance with a fourth embodiment of the present invention;

FIG. 18 is a front view of a padlock in accordance with a fifth embodiment of the present invention;

FIG. 19 is a front view of a padlock in accordance with a sixth embodiment of the present invention;

FIG. 20 is a front view of a padlock in accordance with a seventh embodiment of the present invention;

FIG. 21 is a front view of a padlock in accordance with an eighth embodiment of the present invention;

FIG. 22 is a perspective view of a padlock in accordance with a ninth embodiment of the present invention;

FIG. 23 is a front view of the padlock shown in FIG. 22;

FIG. 24 is a front view of a padlock in accordance with a tenth embodiment of the present invention; and

FIG. 25 is a front view of a padlock in accordance with an eleventh embodiment of the present invention.

### DETAILED DESCRIPTION OF THE PREFERRED EMBODIMENTS

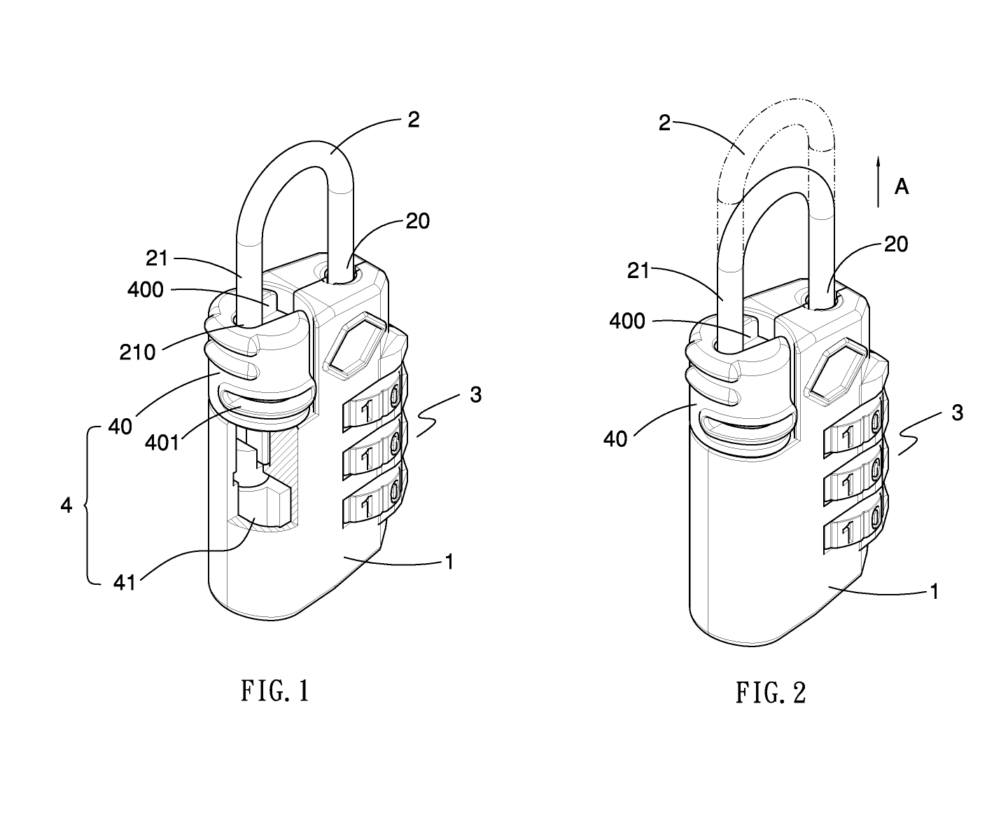

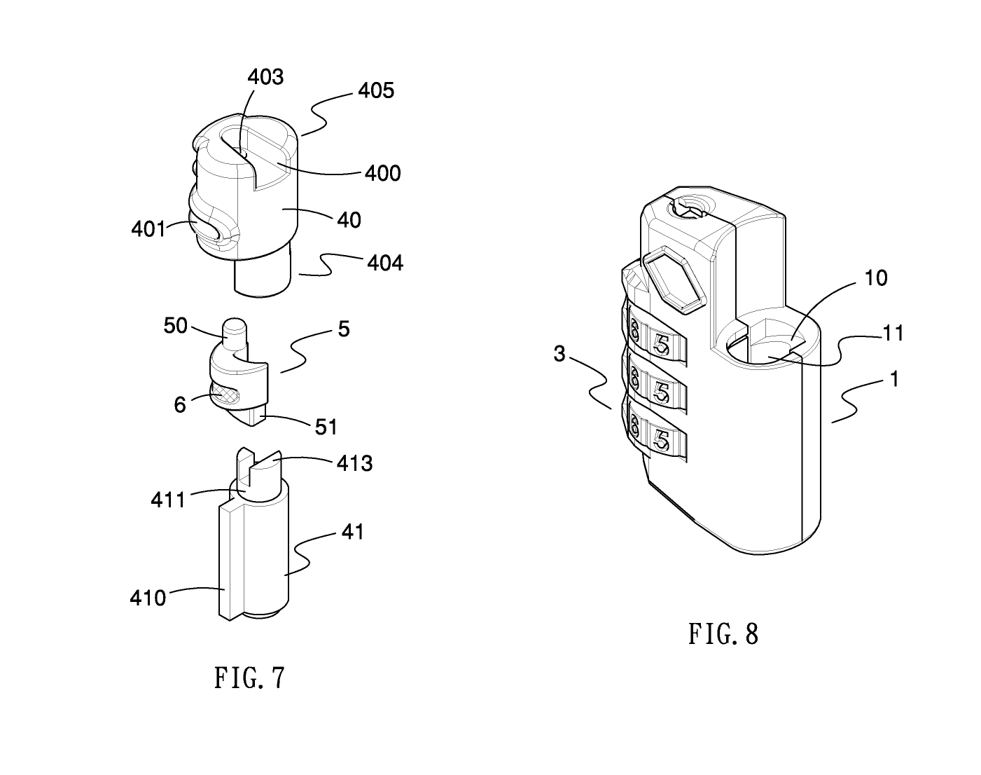

FIGS. 1-10 show a padlock according to a first embodiment of the present invention. As shown in FIGS. 1-5, the padlock comprises a shell 1, a shackle 2, a lock mechanism 4, and an indicator 5. The lock mechanism 4 can be a key-operated lock mechanism or a combination lock mechanism. In the first embodiment, the lock mechanism 4 is a key-operated lock mechanism.

In the first embodiment, the shell 1 includes an opening 11, as can be seen in FIG. 8, in a wall thereof to communicate an interior space of the shell 1 with the exterior of the shell 1. The shackle 2 is substantially U-shaped and mounted on the shell 1. The shackle 2 is formed with a long section 20 movably inserted in the shell 1 and a short section 21 extending from the long section 20 so that they are movable together.

The lock mechanism 4 is mounted on the shell 1, and includes a lock core 41 and a limit knob 40. The lock core 41 is inserted in the shell 1. The limit knob 40 comprises a driving member 404 and a button 405. The driving member 404 is movable within the interior space of the shell 1 via the opening 11 of the shell 1. The button 405 is coupled to the driving member 404 and located out of the shell 1. The driving member 404 is movable by the lock core 41 so as to drive the button 405 to engage with or disengage from the short section 21 of the shackle 2. Additionally, the button 405 of the limit knob 40 includes a top face formed with a recess 400 for receiving an end 210 of the short section 21 of the shackle 2. The recess 400 includes an open end at a periphery of the limit knob 40.

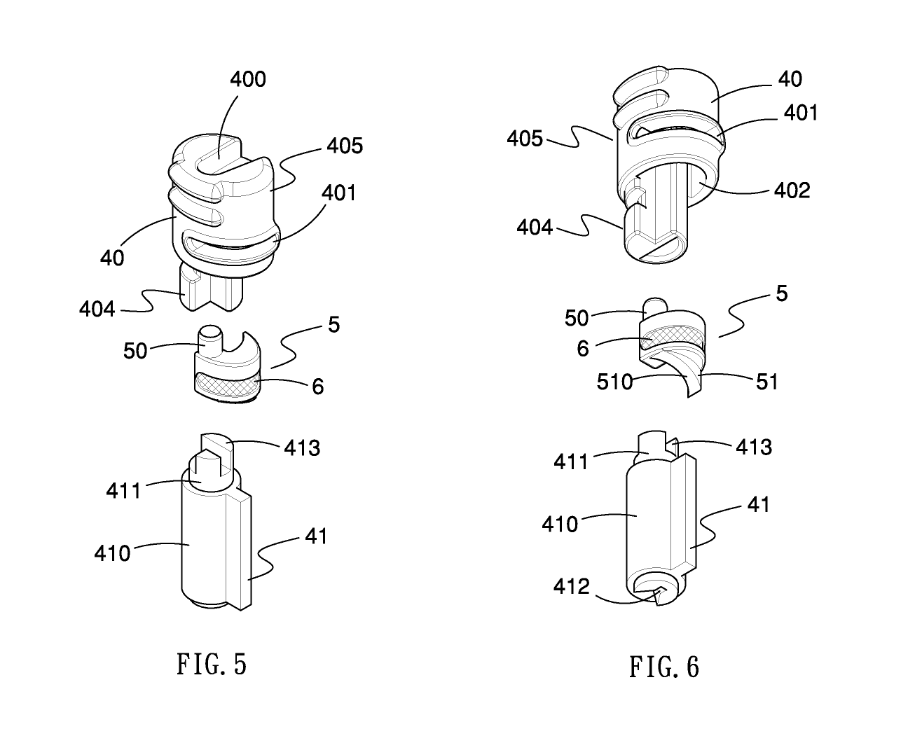

Moreover, the indicator 5 is inserted in the opening 11 of the shell 1 and is capable of moving along a surface of the driving member 404 from the opening 11 of the shell 1 into an indication position out of the shell 1 by operating the lock core 41 of the lock mechanism 4, as shown in FIGS. 5-10.

Referring to FIGS. 4-6, the indicator 5 is formed with an indication portion 6. The button 405 of the limit knob 40 includes a window 401 made in the periphery. In the first embodiment, the indication portion 6 of the indicator 5 is visible from the window 401 of the button 405 when the indicator 5 is in the indication position.

As described above, the lock mechanism 4 is a key-operated lock mechanism. Accordingly, the lock core 41 of the lock mechanism 41 comprises a body 410 and a rotor 411. The rotor 411 is movably received in the body 410, and includes one end made with a keyhole portion 412, and the other end made with a driving portion 413 extending from the body 410 for connecting with the limit knob 40. The keyhole portion 412 of the rotor 411 is arranged for receiving a matching key (not shown). When the matching key is inserted into the keyhole portion 412, the driving portion 413 can accordingly move the limit knob 40.

In addition, the padlock further comprises a combination lock core 3, which is inserted in the shell 1 for locking and unlocking the long section 20 of the shackle 2, as shown in FIGS. 1-4.

FIG. 2 shows that the open end of the recess 400 of the limit knob 40 is directed toward and sealed by the shell 1, and the short section 21 of the shackle 2 is inserted in the recess 400 of the limit knob 40 of the lock mechanism 4 and stopped by the limit knob 40, thus forming a locked state. When the combination lock core 3 is unlocked, the long section 20 of the shackle 2 is unlocked from the combination lock core 3 so that the shackle 2 is movable in a direction indicated by an arrow head A, so as to detach the short section 21 of the shackle 2 from the recess 400 of the limit knob 40 of the lock mechanism 4, thereby forming an unlocked state.

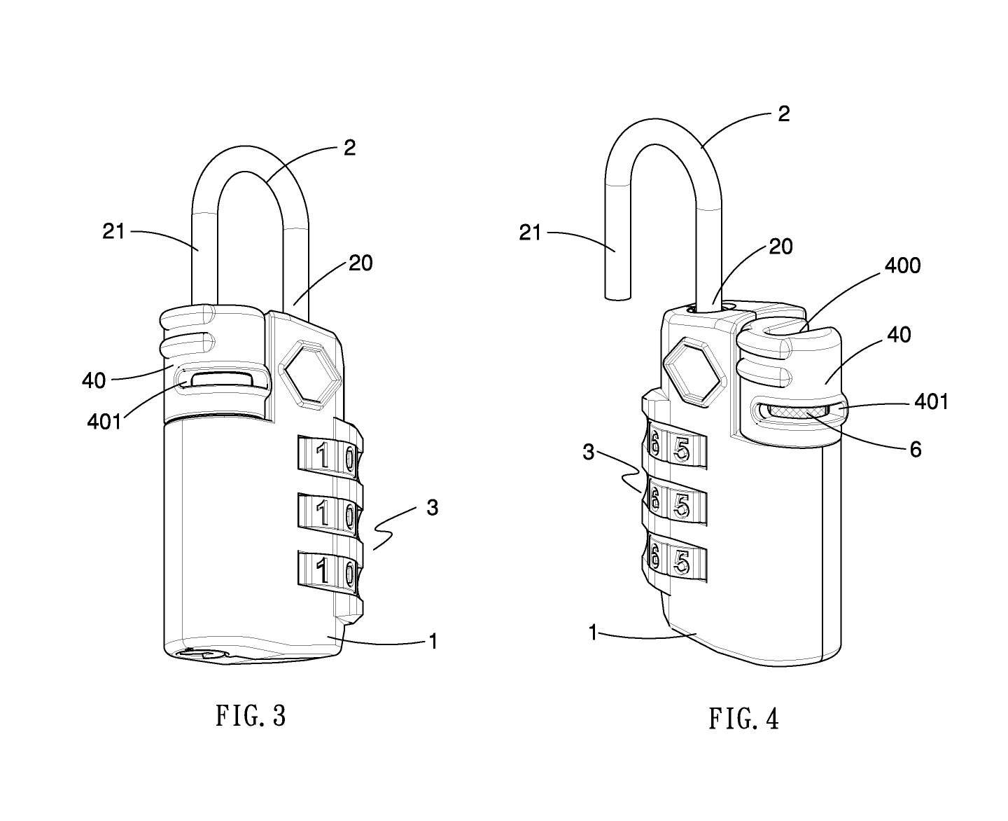

Referring to FIG. 3, when the combination lock core 3 is locked, the long section 20 of the shackle 2 is locked by the combination lock core 3. That is, the short section 21 of the shackle 2 is stopped by the limit knob 40, thereby forming a locked state.

In FIG. 4, when the limit knob 40 of the lock mechanism 4 is moved by the lock core 41 via the matching key, the open end of the recess 400 of the limit knob 40 is released from the shell 1. Accordingly, the short section 21 of the shackle 2 is released from the recess 400 of the limit knob 40 and can be rotated about the long section 20 of the shackle 2, thereby forming an unlocked state.

FIG. 5 shows that the indicator 5 is movably mounted on the driving member 404 of the limit knob 40 of the lock mechanism 4 and includes a protruding portion formed on a first side and hereinafter named as the “shaft 50”, directed toward the limit knob 40. The indication portion 6 of the indicator 5 and is visible from the window 401 of the limit knob 40 when the indicator 5 is in the indication position. Preferably, the indication portion 6 of the indicator 5 is a color, character, number or pattern. For examples, the indication portion 6 of the indicator 5 is printed in red, and the other portion of the indicator 5 is printed in green. Hence, the red of the indication portion 6 clearly visible from the window 401 presents the lock core 41 of the lock mechanism 4 is operated or used.

Furthermore, FIGS. 6-8 show that the button 405 of the limit knob 40 is formed with a chamber 402 facing the shell 1 for receiving the indicator 5. The indicator 5 includes, on a second side, a guide portion 51 formed with a first ramp 510. The recess 400 of the limit knob 40 includes an aperture 403 in communication with the chamber 402. The shaft 50 of the indicator 5 can be inserted into the aperture 403 of the limit knob 40. Additionally, the shell 1 includes a second ramp 10 complementarily in contact with the first ramp 510 of the guide portion 51 of the indicator 5.

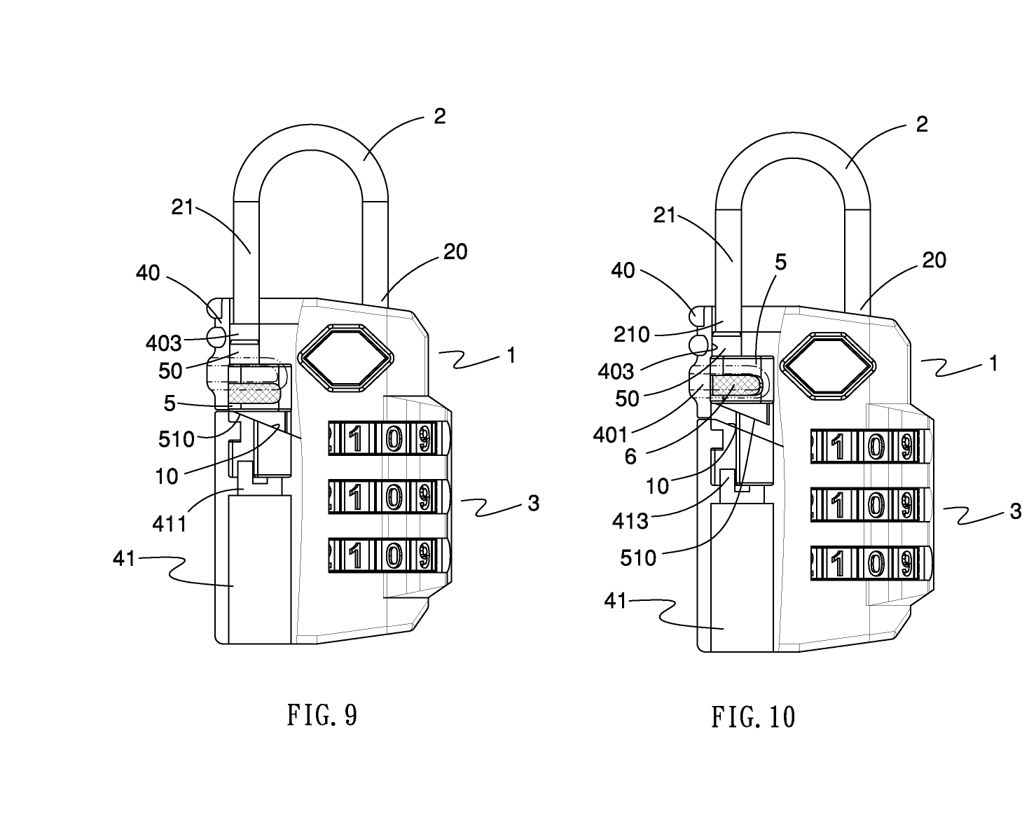

Referring to FIG. 9, the first ramp 510 of the indicator 5 is in contact with the second ramp 10 of the shell 1 so that the indication portion 6 is hidden in the shell 1 and detached from the window 401 of the limit knob 40. Thus, it is indicated that the lock mechanism 4 has not been operated or used. Referring to FIG. 10, as the driving portion 413 of the rotor 411 of the lock mechanism 4 is rotated by the matching key, the limit knob 40 is rotated accordingly until the open end of the recess 400 of the limit knob 40 is released from the shell 1. Therefore, the short section 21 of the shackle 2 is released from the recess 400 of the limit knob 40 and is rotated freely about the long section 20 of the shackle 2 to the unlocked state. At this time, the shaft 50 of the indicator 5 is located further in the aperture 403 of the limit knob 40. Hence, the indicator 5 is driven by the limit knob 40 when the limit knob 40 is rotated by the lock core 41. The indicator 5 is lifted to the indication position by engagement of the first ramp 510 of the indicator 5 with the second ramp 10 of the shell 1 so that the indication portion 6 is exposed and visible from the window 401 of the limit knob 40.

After the limit knob 40 is again rotated by the lock core 41 to re-lock the short section 21 of the shackle 2, the indicator 5 is limited by the chamber 402 and the aperture 403 of the limit knob 40 so that the indicator 5 is not moved along with the driving member 404 of the limit knob 40, i.e., the indicator 5 is kept in the indication position. Thus, it is indicated that the lock mechanism 4 has been operated. Additionally, as the combination lock core 3 is unlocked, the end 210 of the short section 21 of the shackle 2 can be pushed into the aperture 403 of the limit knob 40 so as to push the shaft 50 of the indicator 5 downward to move the indicator 5 away from the indication position, namely to reset the indication portion 6. Alternatively, the shackle 2 can be pulled outward and rotated away from the limit knob 40 so as to allow an insert (not shown) inserting into the aperture 403 of the limit knob 40 to push the shaft 50 of the indicator 5 downward, thus moving the indicator 5 away from the indication position.

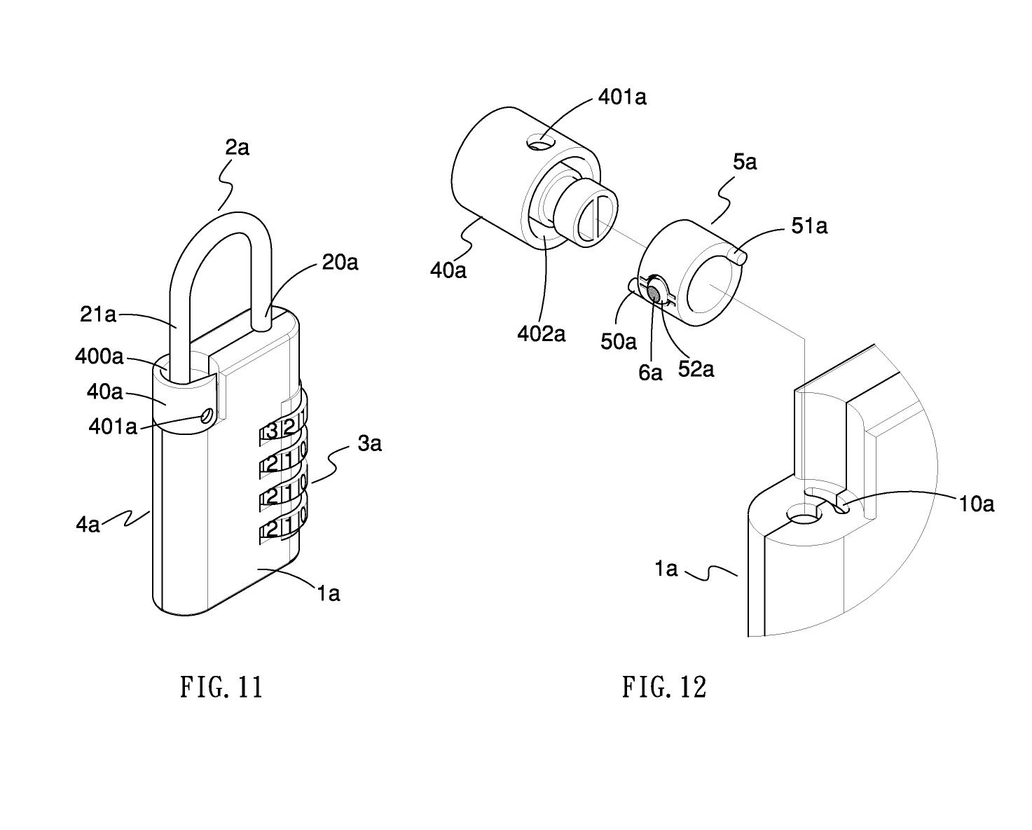

Referring to FIG. 11, a padlock in accordance with a second embodiment of the present invention includes a structure like that of the first embodiment.

Referring to FIG. 12, a shell la includes an arc-shaped slot 10a, and an indicator 5a includes a first side provided with a first post 50a and a second side provided with a second post 51a inserted in the slot 10a of the shell 1a in a sliding manner. The indicator 5a includes a periphery provided with an elastic protrusion 52a corresponding to the window 401a of the limit knob 40a, and the indication portion 6a is mounted on the elastic protrusion 52a.

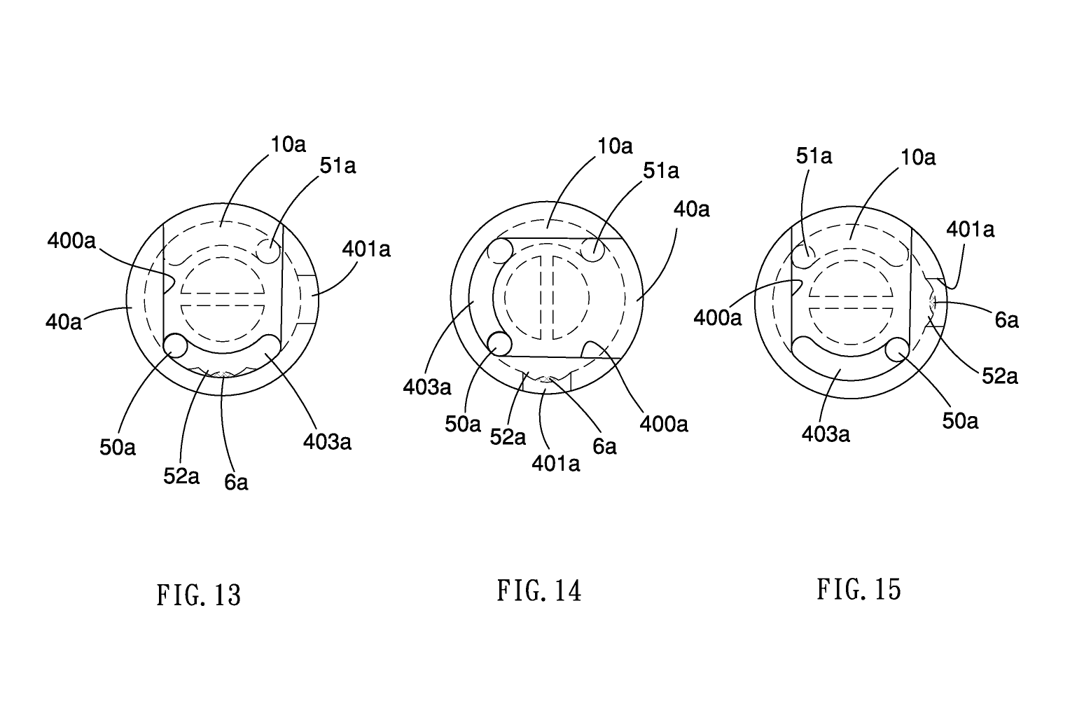

Referring to FIG. 13, a recess 400a of a limit knob 40a includes an arc-shaped slot 403a in communication with a chamber 402a, and the first post 50a of an indicator 5a is inserted in the slot 403a of the limit knob 40a in a sliding manner.

Referring to FIG. 14, the limit knob 40a is rotated clockwise so that the recess 400a of the limit knob 40a is in the opened or unlocked state. At the time, the second post 51a of the indicator 5a is limited by a terminal side of the slot 10a of the shell 1a so that the indicator 5a is not moved with the limit knob 40a, while a window 401a of the limit knob 40a is moved and to aligned with the elastic protrusion 52a so that the indication portion 6a is exposed and visible from the window 401a of the limit knob 40a.

Referring to FIG. 15, the limit knob 40a is rotated counterclockwise to the original position so that the recess 400a of the limit knob 40a is in the closed or locked state. At this time, the elastic protrusion 52a is inserted into the window 401a of the limit knob 40a so that the indicator 5a is moved with the limit knob 40a, and the indication portion 6a is still exposed from the window 401a of the limit knob 40a, which indicates that the lock mechanism 4a has been operated.

When the combination lock core 3a is unlocked, the shackle 2a is pulled outward and is rotate from the limit knob 40a. Then, a tool (not shown) can be inserted into the slot 403a of the limit knob 40a to cause the first post 50a of the indicator 5a to return to its original position so that the indication portion 6a is detached from the window 401a of the limit knob 40a and is hidden in the limit knob 40a.

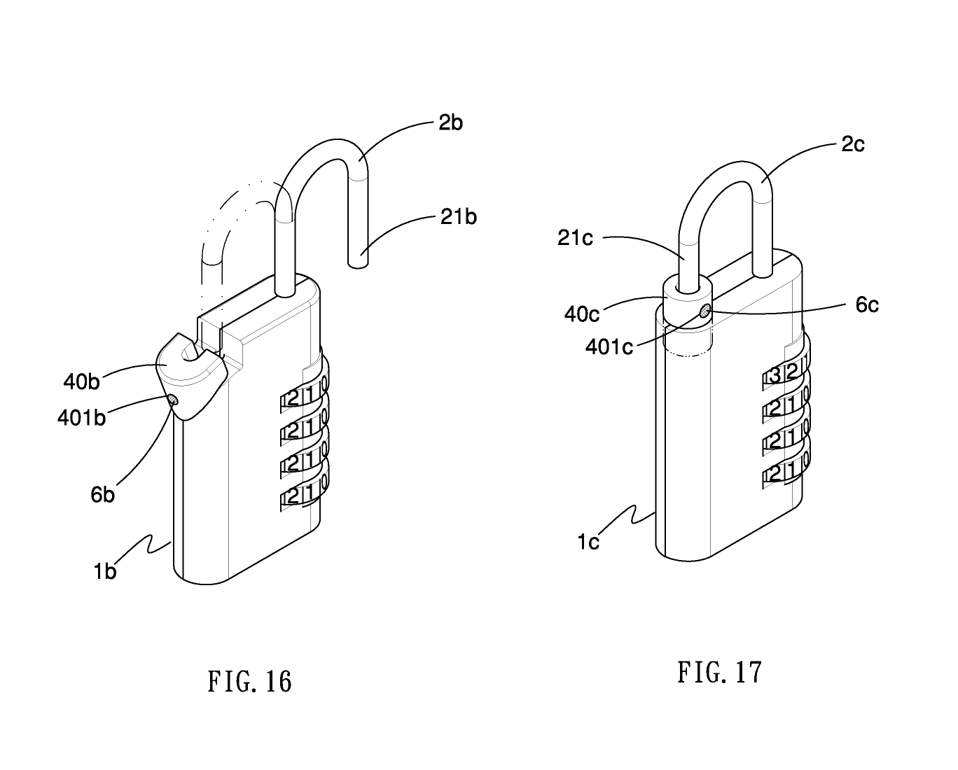

Referring to FIG. 16, a padlock in accordance with a third embodiment of the present invention includes a structure like that of the above embodiments. A limit knob 40b is pivotally mounted on an upper side of a shell 1b to limit a short section 21b of a shackle 2b so that the short section 21b of the shackle 2b is in a locked state, or release the short section 21b of the shackle 2b so that the short section 21b of the shackle 2b is in an unlocked state. When the short section 21b of the shackle 2b is in the unlocked state, the indication portion 6b is moved with the limit knob 40b and is visible from a window 401b of the limit knob 40b.

Referring to FIG. 17, a padlock in accordance with a fourth embodiment of the present invention includes a structure like that of the above embodiments. A limit knob 40c is retractably mounted on an upper side of a shell 1c to limit a short section 21c of a shackle 2c so that the short section 21c of the shackle 2c is in a locked state, or release the short section 21c of the shackle 2c so that the short section 21c of the shackle 2c is in an unlocked state. When the short section 21c of the shackle 2c is in the unlocked state, the indication portion 6c is moved with the limit knob 40c and exposed from a window 401c of the limit knob 40c.

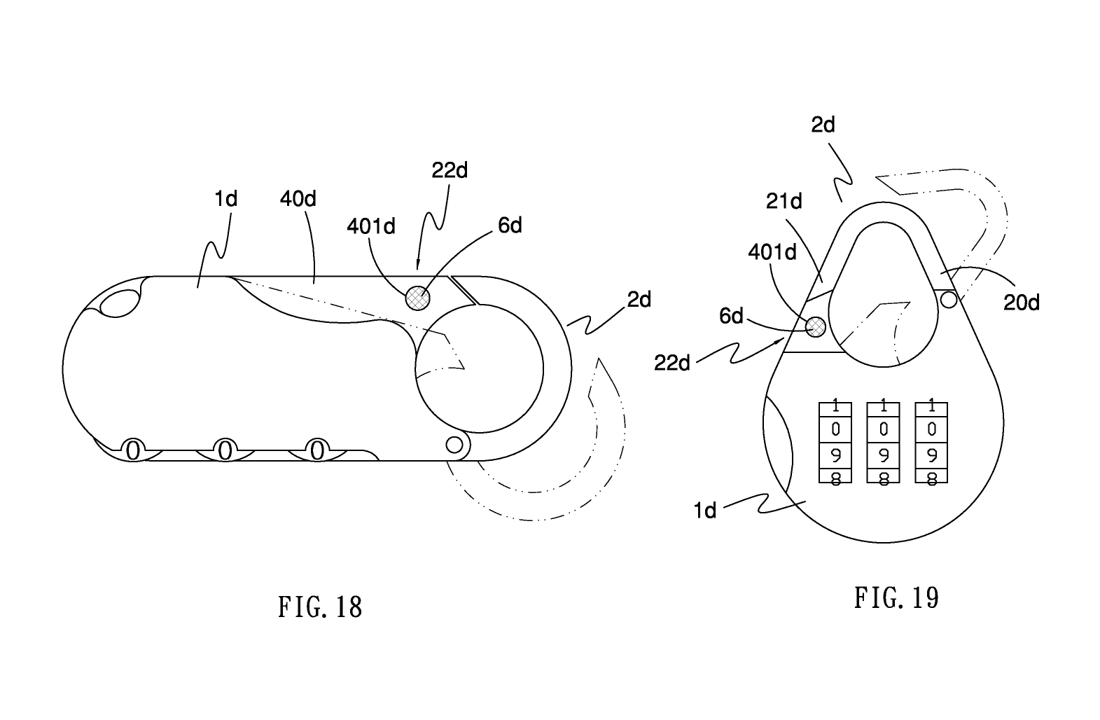

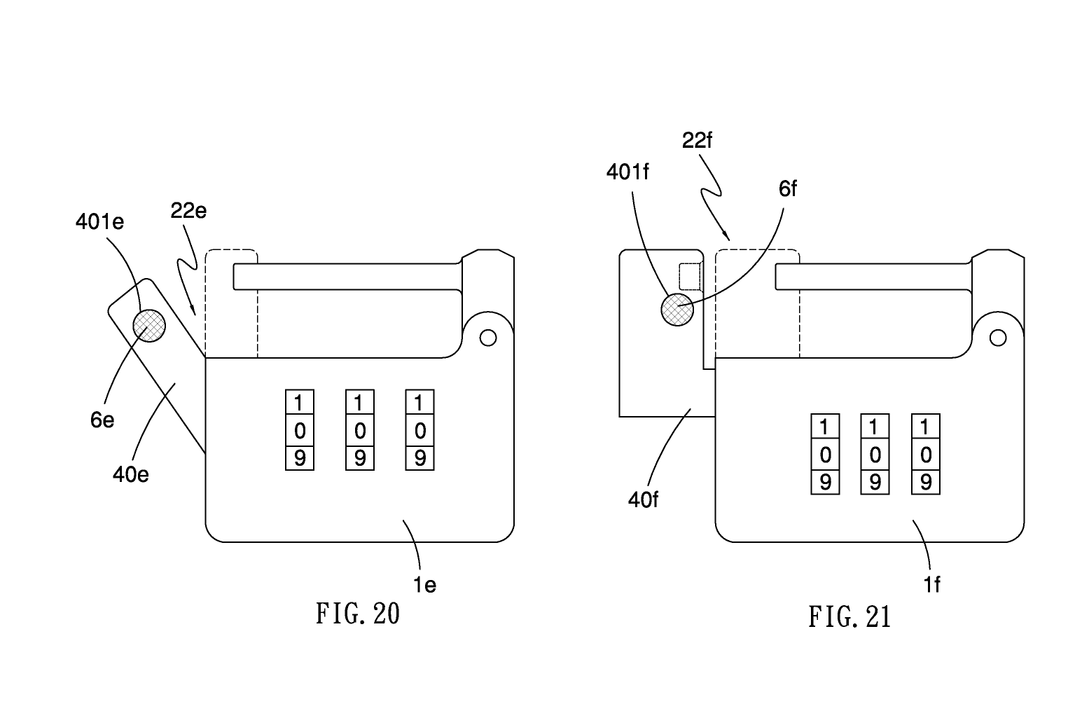

FIG. 18 shows a fifth embodiment of the present invention, and FIG. 19 shows a sixth embodiment of the present invention. Both embodiments respectively show a padlock includes a structure like that of the above embodiments. A long section 20d of a shackle 2d is pivotally mounted on a side of a shell 1d, and a gap 22d is defined between an end of a short section 21d of a shackle 2d and the shell 1d. A limit knob 40d is pivotally mounted on the shell 1d and inserted in the gap 22d to form a locked state. As the limit knob 40d is pressed towards the shell 1d, the gap 22d is opened to form an unlocked state so that the indication portion 6d is moved with the limit knob 40d and exposed from a window 401d of the limit knob 40d.

Referring to FIG. 20, a padlock in accordance with a seventh embodiment of the present invention includes a structure like that of the above embodiments. A limit knob 40e is pivotally mounted on the shell 1e and inserted in a gap 22e to form a locked state. When the limit knob 40e is moved outward relative to the shell 1e, the gap 22e is opened to form an unlocked state so that the indication portion 6e is moved with the limit knob 40e and exposed from a window 401e of the limit knob 40e.

Referring to FIG. 21, a padlock in accordance with an eighth embodiment of the present invention includes a structure like that of the above embodiments. A limit knob 40f is linearly and movably mounted on a shell if and inserted in a gap 22f to form a locked state. As the limit knob 40f is linearly moved outward relative to the shell 1f, the gap 22f is opened to form an unlocked state so that an indication portion 6f is moved with the limit knob 40f and exposed from a window 401f of the limit knob 40f.

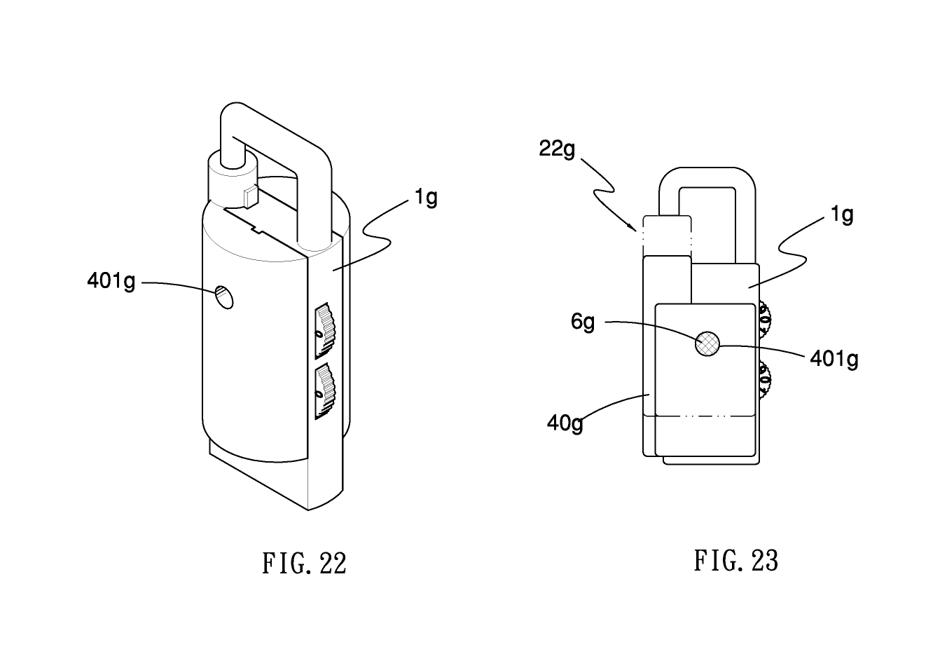

Referring to FIGS. 22 and 23, a padlock in accordance with a ninth embodiment of the present invention includes a structure like that of the above embodiments. A limit knob 40g is partially extended from a side of a shell 1g and is longitudinally movable on the shell 1g to open a gap 22g so as to form an unlocked state so that an indication portion 6g is moved with the limit knob 40g and exposed from a window 401g of the limit knob 40g.

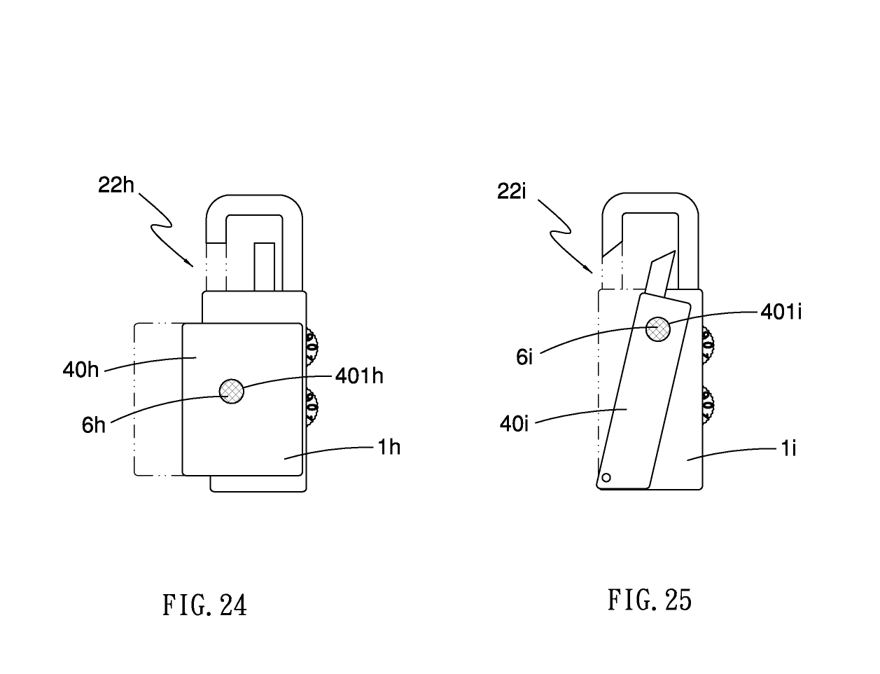

Referring to FIG. 24, a padlock in accordance with a tenth embodiment of the present invention includes a structure like that of the above embodiments. A limit knob 40h is transversely movable on a shell 1h to open a gap 22h so as to form an unlocked state so that an indication portion 6h is moved with the limit knob 40h and exposed from a window 401h of the limit knob 40h.

Referring to FIG. 25, a padlock in accordance with an eleventh embodiment of the present invention includes a structure like that of the above embodiments. A limit knob 40i includes an end pivotally mounted on a bottom of a shell 1i. Thus, the limit knob 40i is pivoted on the shell 1i to open a gap 22i so as to form an unlocked state so that an indication portion 6i is moved with the limit knob 40i and exposed from a window 401i of the limit knob 40i.

After a customs inspector includes unlocked the padlock for checking the luggage, case or bag, the indication portion is exposed and visible from the window of the limit knob for reminding a padlock owner whose padlock has been operated or used and luggage may have been inspected by the customs inspector. In addition, the padlock owner can directly and easily judge if the customs inspector includes operated or used the padlock for checking the luggage. Furthermore, in the present invention, the indicator can be moved to the indication position not only by using the matching key to operate the lock core of the lock mechanism as above described, but also by any object which can reach or access to the lock core of the lock mechanism, especially the object which can reach or access to the indicator via the lock core, so as to further remind the padlock owner that the lock mechanism of the padlock has been used or touched.

In the foregoing embodiments, the indicator is inserted in the limit knob. However, in another embodiment or application, the indicator can be mounted outside the limit knob entirely or partially, and the window of the limit knob can be omitted. In the foregoing embodiments, the indicator can be moved in a linear manner, i.e., lifted and lowered. In another embodiment or application, the indicator can however be moved in an angular manner, i.e., pivoted. In the foregoing embodiments, the lock core of the lock mechanism can include a first member non-movably inserted in the shell of the padlock, and a second member movably inserted in the first member and can be rotated by the matching key. However, in another embodiment, the lock core of the lock mechanism can be a one-piece element movably inserted in the shell of the padlock and can be rotated by the matching key.

Although the invention has been explained in relation to the foregoing embodiments, it is to be understood that many modifications and variations can be made without departing from the scope of the present invention. It is contemplated that the appended claim or claims will cover such modifications and variations that fall within the true scope of the invention.

1. A lock comprising:
a shell;
a shackle comprising a short section and a long section;
a first lock core inserted in the shell and movable between an unlocking position and a locking position, wherein the first lock core prevents rotation of the short section of the shackle about the long section of the shackle in the locking position;
a second lock core inserted in the shell and movable between an unlocking position and a locking position for preventing linear movement of the long section of the shackle;
an indicator operatively connected to the first lock core and movable between an original position and an indication position;
wherein the indicator is movable into the indication position from the original position by the first lock core when the first lock core is moved into the unlocking position from the locking position a first time before the long section of the shackle is linearly moved relative to the second lock core;
wherein the indicator is not returned into the original position from the indication position by the first lock core when the first lock core is returned into the locking position from the unlocking position; and
wherein the indicator is kept in the indication position once the first lock core is moved into the unlocking position from the locking position.

2. The lock according to claim 1 wherein the indicator is returned into the original position from the indication position when the long section of the shackle is linearly moved relative to the second lock core.

3. The lock according to claim 1 wherein the indicator is linearly movable to the indication position.

4. The lock according to claim 1 wherein the first lock core comprises a rotor formed with a keyhole portion operable to rotate the rotor which does not cause the indicator to move into the original position from the indication position.

5. The lock according to claim 4 wherein the rotor is configured to move the indicator into the indication position from the original position.

6. The lock according to claim 5 wherein the rotor is located under the indicator and operable to move the indicator upwardly into the indication position.

7. The lock according to claim 4 wherein the indicator is located between the rotor and the short section of the shackle.

8. The lock according to claim 1 wherein the shell comprises an opening, wherein the short section of the shackle can be pressed downward and toward the opening so as to return the indicator into the original position from the indication position through the opening.

9. The lock according to claim 1 further comprising a reset element, wherein the reset element is movably mounted on the shell and operable to return the indicator into the original position from the indication position.

10. The lock according to claim 9 wherein the reset element is an end of the short section of the shackle.
